(19) United States
(12) Patent Application Publication
(10) Pub. No.: US 2012/0046933 A1
(43) Pub. Date: Feb. 23, 2012

(54) System and Method for Translation

(76) Inventors: John Frei, (US); Yan Auerbach, (US)

(21) Appl. No.: 13/152,500

(22) Filed: Jun. 3, 2011

Related U.S. Application Data
(60) Provisional application No. 61/351,775, filed on Jun. 4, 2010.

(51) Int. Cl. G06F 17/28

(52) U.S. Cl. 704/2

(57) ABSTRACT

A system and method for translating speech from one language to another is disclosed herein.

### CROSS-REFERENCE TO RELATED APPLICATIONS

This application claims the benefit of U.S. Provisional Application Ser. No. 61/351,775 filed Jun. 4, 2010, entitled “Speechtrans™ Translation Software Which Takes Spoken Language and Translates to Another Spoken Language”, Attorney Docket No. 8331256, the disclosure of which application is hereby incorporated herein by reference in its entirety.

### BACKGROUND OF THE INVENTION

In the existing art, translation of text from one language to another involves the use dictionaries to translate on a word-by-word basis. This approach is slow and subject to inaccuracies arising from a lack of context for the individual words being translated. Accordingly, there is a need in the art for an improved system and method for translating between two languages.

### SUMMARY OF THE INVENTION

In one embodiment, a combination of speech to text conversion in a first language, text-to-text translation between two languages, and text to speech conversion may be employed to expedite and facilitate real-time translation between people, with different native languages, wishing to communicate.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a system for speech to speech translation in accordance with an embodiment of the present invention;

FIG. 2 is a block diagram showing an example of the operation of an embodiment of the present invention; and

FIG. 3 is a block diagram of a computer system useable in conjunction with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

One embodiment here takes spoken language and translates to another spoken language.

An embodiment of the present invention relates to translation software, which takes spoken language and translates to another spoken language.

Currently, people tend to communicate using hard copy dictionaries, electronic dictionaries, or learning new languages in their entirety. The present invention offers easy interaction with others who speak a different language that are not currently available.

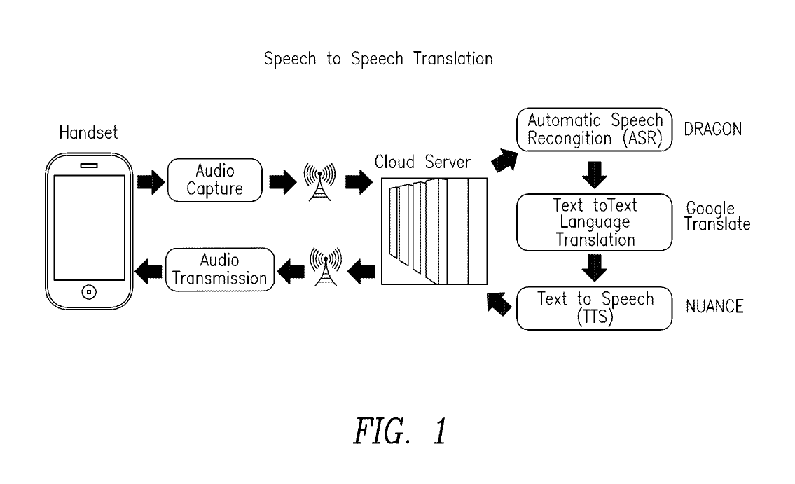

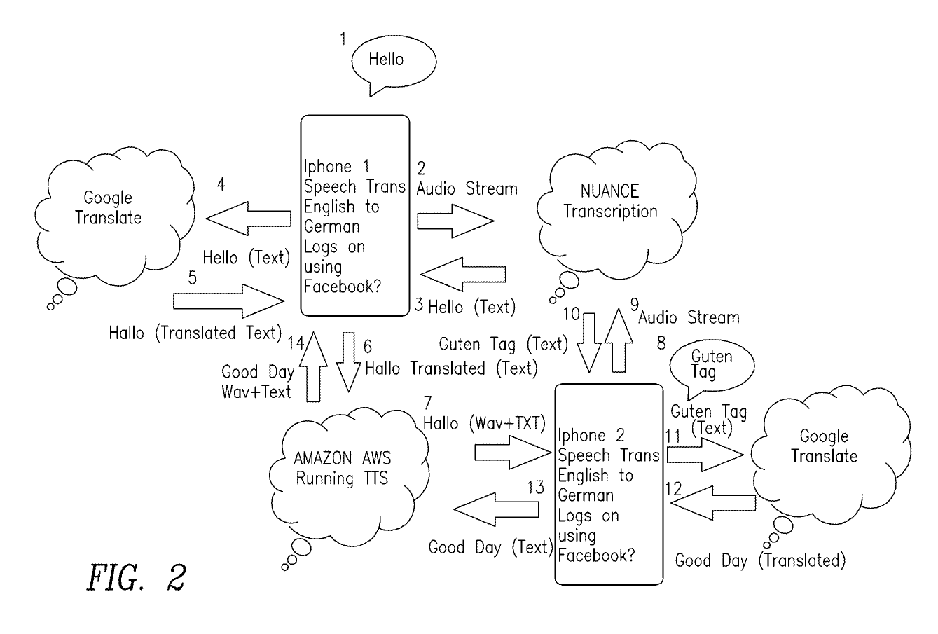

Please refer to FIGS. 1 and 2 in connection with the reference numerals used below, in which each reference numeral corresponds to a separate step. The steps may include:

4 Informing; 6 Inquiring; 8 Providing; 10 Language Selection; 12 First decision; 14 Language Translation; 16 Language Translation; 18 Second decision; and/or 20 Language more.

The method 2 describes a method of spoken language translation based on an input from a user (translator) and receiver (translatee).

A method according one embodiment can include at least three steps which are listed below. The invention is not limited to performing the steps in any particular order.

Step A—Automatic Speech Recognition (ASR).

Step B—Text to Text Translation.

Step C—Text to Speech (TTS).

A method according to one embodiment may include the following steps:

Step 1—Speechtrans™ software is downloaded onto a smart phone.

Step 2—Speechtrans™ software is opened on the Smart phone.

Step 3—Push and release the record button to active the microphone recording.

Step 4—Push the Stop button once done with speaking desired sentence or sentences desired for translation.

Step 5—Spoken Language is then sent to Cloud Server in order for Automatic Speech Recognition (ASR) to transcribe the spoken language to text.

Step 6—The Text is then translated from the selected language into the desired language.

Step 7—Text, translated Text and Text to Speech (TTS) is sent back to the smart phone.

Step 8—Steps 3-7 are repeated with Translatee and Translator alternating turns.

In the step of Informing 4, a user of the present method (such as a business person, tourist or student utilizing a Smart Phone and Speechtrans™ Translation Software) interacts with a receiver—a person who speaks a foreign language (such as a business person or native to the country the tourist is visiting) by pushing and releasing a button on their smart phone to start the translation process. Pressing the “stop” button may operate to stop the Automatic Speech Recognition (ASR) and start the Translation process. The spoken language is identified and displayed as text at the top of the Screen along with the translated text being displayed at the bottom of the screen. This step may be performed through any means of transmitting information known in the art, such as through a verbal signal, a written signal (e.g., a menu), an electronic signal (e.g., email), a visual signal (e.g., video monitor), etc. Further, this step is not limited to offering merely one option. For example, the user may offer the business person or native as few as two language choices, with no upper limit on choices, but preferably not more than five choices.

In the step of Inquiring 6, the user of the method may ask the translatee what language he or she prefers among the choices offered, and may then confirm the translatee's response. The user could make this inquiry in any known manner, such as by asking the translatee his preference and then listening for a vocal response, by providing a selection option on the phone upon which the consumer can make a written response, and/or by providing an electronic data entry input device (e.g., mouse, keyboard, touchpad.)

The step of Informing 4 may be omitted if a translatee already knows her options, such as by being served by the translator on a previous occasion.

In one embodiment, the translatee only has two choices, such as English to German and English to Spanish, in which case First Decision 12 may be omitted. Other embodiments including cases in which the translatee can only choose between English to Chinese and French to German or Spanish to Italian and Danish to Swedish with corresponding changes to the flow diagram. In another embodiment, the translatee may be given more than three options, such as an additional option of English to German with a Swiss Dialect, with corresponding changes to the flow diagram.

In another embodiment, the method could include translating text or speech into a Language presumed to be that of the Translatee, and asking the Translatee for Confirmation. If the Translatee does not provide a confirmation, the translator may then ask which language or dialect to translate the text or speech into. Based on the received information, the translator may then continue to conduct translation from English into a desired target Language, add various dialects, use various different speech patterns (that of a woman or a man, etc.), and/or start the language detection software to help identify the desired Language for the translatee.

Chronological order is shown in the flow diagram. The process preferably begins at the step of Informing 4 and ends at the step of Language Translation 14. As shown in the diagram, the step of Informing 4 preferably occurs before the step of Inquiring 6, which preferably occurs before the step of Providing 8, and so forth. However, the order of many of these steps may be changed. By way of example but not limitation, the step of Providing 8 may occur during or before the step of Informing 4 or during or before the step of Inquiring 6. Further, even the step of Language Selection 10 could occur during or before either or both of the steps of Informing 4 and Inquiring 6, as long as sufficient time remains to make the proper decisions in First and Second Decisions 12, 18.

In another embodiment, the steps of Language Selection 10, Language Translation 16, and Language More 20 could be altered or adjusted so that, if the preference indicated in the step of Language Selection 10 is English to Chinese, the Translation occurs with ability to modify the process so as to incorporate dialect into step Language More 20.

As another example, the embodiment shown may be implemented by a computer and/or a machine. However, a human (e.g., business person, tourist) may not appear to execute the steps and decisions in the formal manner shown. For example, after the step of Inquiring 6, a human may make a decision to execute the steps along one of three different flow paths, each path corresponding to a preference indicated by the translatee. A first path, corresponding to English to German, may include these steps, in order: Language Selection 10—select English to German Translation on smart phone enabled with Speechtrans™ Translation Software; pushing and releasing the speech button on the smart phone to recognize spoken language in English, pushing stop once finished speaking, which automatically Translates English to German. Await Translatee confirmation of understanding and push record button on smart phone to enable the Translatee to translate spoken German into English.

The method works as follows. When a translatee is informed in the step of Informing 4 about his choices, he then forms a preference among those choices. This preference is subsequently revealed to the translator in the step of Inquiring 6, when the translator inquires about the translatee's preference and the translatee provides the translator with preference information. Before, during, or after these steps, the translator executes the step of Providing 8 by providing tools (Smart Phone, Speechtrans™ Translation Software, Visual Display, GPS, etc) for producing the Speech Recognition, Translation and Audio Output preferred by the translatee. Subsequently, the translator performs the Language Selection 10 step by selecting the desired language in the Cell Phone Translation Software Menu.

If the translatee opts for English to Spanish, then the translator in First Decision 12 will proceed to the step of Language Selection 10, in which he selects Spanish in the Translation Software Menu. If the translatee opts for something other than Spanish, then the translator in First Decision 12 will proceed to the step of Language Detection 16, in which he will use the smart Phone, Language Translation Software, Visual Display, etc. to determine the appropriate Language to use, in which the Dialect can be identified in Language More 20 to ensure proper Language Translation. Then, if the translatee opts for French, then the user in Second Decision 18 will proceed to the step of Language Translation 14, described previously. If, instead, the consumer opts for Portuguese, then the user in Second Decision 18 will proceed to the step of Language Selection 10, in which he will continue to identify the appropriate Language. After this step, the translator will proceed to the step of Language Translation 14, after which the process ends.

A Translator may download the software to a smart phone device to implement a method according to the present invention. Such a smart Phone may include an information output device (such as a monitor or display), an information input device (such as a keyboard, touchpad, or microphone), and the mechanical means to translate from one language to another according to the preference of a translatee.

The available choices for Language Translation could be presented to a translatee via the information output device. The translatee could then express a preference regarding his Language Selection via the information input device. Based on this information, the Language Translation Software could then Translate Desired Languages on the translatee's input.

The Language Translation could then be provided to the translatee via audio output, visual output, and/or tactile output. The method could be used by any person or machine that is in need of Language Translation.

In a different field of technology, the field of learning a new Language, a Language Learning system may implement a variation of the method by presenting the available Language choices to the Student, receiving preference information, and then teaching a specific Language to the Student based on this information.

Thus, various of the concepts discussed herein may be applied to: Language Translation, Learning a new Language, Communication with any person in the World, potential for inter-species communication.

In one embodiment, the Process of Language Translation and repetition would enable both the Translator and the Translatee to benefit from direct Language Translation as a means of communication whereas without, communication would be extremely difficult.

In one embodiment, this invention may eliminate language barriers. Downloadable software to a smart phone can allow full translation from spoken language to another spoken language, allowing people who speak different languages to communicate with each other in their native language. By using the latest in Automatic Speech Recognition (ASR), Language translation and Text to Speech (TTS) it allows users to speak in their native language and the software does the translation.

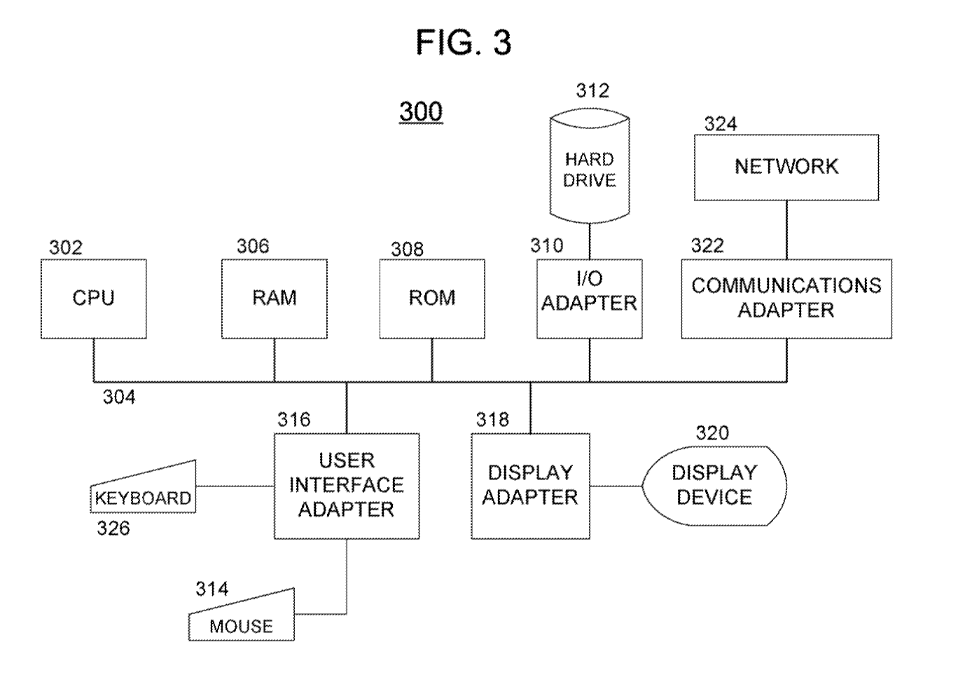

FIG. 3 is a block diagram of a computing system 300 adaptable for use with one or more embodiments of the present invention. Central processing unit (CPU) 302 may be coupled to bus 304. In addition, bus 304 may be coupled to random access memory (RAM) 306, read only memory (ROM) 308, input/output (I/O) adapter 310, communications adapter 322, user interface adapter 306, and display adapter 318.

In an embodiment, RAM 306 and/or ROM 308 may hold user data, system data, and/or programs I/O adapter 310 may connect storage devices, such as hard drive 312, a CD-ROM (not shown), or other mass storage device to computing system 300. Communications adapter 322 may couple computing system 300 to a local, wide-area, or global network 324. User interface adapter 316 may couple user input devices, such as keyboard 326, scanner 328 and/or pointing device 314, to computing system 300. Moreover, display adapter 318 may be driven by CPU 302 to control the display on display device 320. CPU 302 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

An Appendix has been included herewith which includes the disclosure of the Provisional application that this application claims the benefit of. The scope of the present invention is not limited by the features of the specific embodiments discussed in the Appendix.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### APPENDIX

### Description of Various Embodiments

The present invention relates to translation software, which takes spoken language and translates to another spoken language.

Currently, people only can communicate using hard copy dictionaries, electronic dictionaries, or learning a new languages The present invention offers easy interaction with others who speak a different language that are not currently available.

Please refer to the drawings at the end of this example for a key to the reference numbers.
Reference Number/Name of Step
2 Method
4 Informing
6 Inquiring
8 Providing
10 Language Selection
12 First decision
14 Language Translation
16 Language Translation
18 Second decision
20 Language more

The method 2 describes a method of spoken language translation based on an input from a user (translator) and receiver (translatee).

Speechtrans™ consists of at least 3 integral steps which are listed below in no specific order.
Step A—Automatic Speech Recognition (ASR)
Step B—Text to Text Translation
Step C—Text to Speech (TTS)

The invention is comprised of the following steps:
Step 1—Speechtrans™ software is downloaded onto a smart phone.
Step 2—Speechtrans™ software is opened on the Smart phone.
Step 3—Push and release the record button to active the microphone recording.
Step 4—Push the Stop button once done with speaking desired sentence or sentences desired for translation.
Step 5—Spoken Language is then sent to Cloud Server in order for Automatic Speech Recognition (ASR) to transcribe the spoken language to text.
Step 6—The Text is then translated from the selected language into the desired language.
Step 7—Text, translated Text and Text to Speech (TTS) is sent back to the smart phone.
Step 8—Steps 3-7 are repeated with Translatee and Translator alternating turns.

In the step of Informing 4, the user of the present method (such as a business person, tourist or student utilizing a Smart Phone and Speechtrans™ Translation Software) interacts with a receiver-person who speaks a foreign language (such as a business person or native to the country the tourist is visiting) by pushing and releasing a button on their smart phone to start the translation process, pressing stop will stop the Automatic Speech Recognition (ASR) and start the Translation. The spoken language is identified and displayed as text at the top of the Screen along with the translated text being displayed at the bottom of the screen. This step may be performed through any means of transmitting information known in the art, such as through a verbal signal, a written signal (e.g., a menu), an electronic signal (e.g., email), a visual signal (e.g., video monitor), etc. Further, this step is not limited to offering one option. For example, the user may offer the business person or native as few as two language choices, with no upper limit on choices, but preferably not more than five choices.

In the step of Inquiring 6, the user of the method inquires the translatee about his preferred language among the choices offered, and then confirms the translatee's response. The user could make this inquiry in any known manner, such as by asking the translatee his preference and then listening for a vocal response, by providing a selection option on the phone upon which the consumer can make a written response, by providing an electronic data entry input device (e.g., mouse, keyboard, touchpad.)

The step of Informing 4 may be omitted if a translatee already knows her options, such as by being served by the translator on a previous occasion.

In one embodiment, the translatee only has two choices, such as English to German and English to Spanish, in which case First Decision 12 may be omitted. Other embodiments including cases in which the translatee can only choose between English to Chinese and French to German or Spanish to Italian and Danish to Swedish with corresponding changes to the flow diagram. In another embodiment, the translatee may be given more than three options, such as an additional option of English to German with a Swiss Dialect, with corresponding changes to the flow diagram.

In another embodiment, the method could include the possibility of translating language into presumed Language to the Translatee and asking the Translatee for Confirmation. If the Translatee does not give confirmation, the translator may then inquire as to how to improve the Language Translation into a different Language or a different dialect. Based on the received information, the translator may then continue to Translate Language for English to desired Language, add various dialects, use various different speech patterns (that of a woman or a man, etc.), or Start the Language Detection software to help identify the desired Language for the translatee.

Chronological order is shown in the flow diagram. The process preferably begins at the step of Informing 4 and ends at the step of Language Translation 14. As shown in the diagram, the step of Informing 4 preferably occurs before the step of Inquiring 6, which preferably occurs before the step of Providing 8, and so forth. However, the order of many of these steps may be changed. By way of example but not limitation, the step of Providing 8 may occur during or before the step of Informing 4 or during or before the step of Inquiring 6. Further, even the step of Language Selection 10 could occur during or before either or both of the steps of Informing 4 and Inquiring 6, as long as sufficient time remained to make the proper decisions in First and Second Decisions 12, 18.

In another embodiment, the steps of Language Selection 10, Language Translation 16, and Language More 20 could be altered or adjusted so that, if the preference indicated in the step of Language Selection 10 is English to Chinese, the Translation occurs with ability to modify to incorporate dialect in step Language More 20.

As another example, the embodiment shown represents an embodiment that may be implemented by a computer and/or machine. However, a human (e.g., business person, tourist) may not appear to execute the steps and decisions in the formal manner shown. For example, after the step of Inquiring 6, a human may make a decision to execute the steps along one of three different flow paths, each path corresponding to a preference indicated by the translatee. A first path, corresponding to English to German, may include these steps, in order: Language Selection 10—select English to German Translation on smart phone enabled with Speechtrans™ Translation Software; pushing and releasing the speech button on the smart phone to recognize spoken language in English, pushing stop once done speaking, which automatically Translates English to German. Await Translatee confirmation of understanding and push record button on smart phone to enable the Translatee to translate spoken German into English.

The method works as follows. When a translatee is informed in the step of Informing 4 about his choices, he then forms a preference among those choices. This preference is subsequently revealed to the translator in the step of Inquiring 6, when the translator inquires about the translatee's preference and the translatee provides the translator with preference information. Before, during, or after these steps, the translator executes the step of Providing 8 by providing the necessary tools (Smart Phone, Speechtrans™ Translation Software, Visual Display, GPS, etc) for producing the Speech Recognition, Translation and Audio Output preferred by the translatee. Subsequently to this step, the translator performs the Language Selection 10 step by selecting the desired language in the Cell Phone Translation Software Menu.

If the translatee opted for English to Spanish, then the translator in First Decision 12 will proceed to the step of Language Selection 10, in which he selects Spanish in the Translation Software Menu. If the translatee opted for something other than Spanish, then the translator in First Decision 12 will proceed to the step of Language Detection 16, in which he will use the smart Phone, Language Translation Software, Visual Display, etc. to determine the appropriate Language to use, in which the Dialect can be identified in Language More 20 to ensure proper Language Translation. Then, if the translatee opted for French, then the user in Second Decision 18 will proceed to the step of Language Translation 14, described previously. If, instead, the consumer opted for Portuguese, then the user in Second Decision 18 will proceed to the step of Language Selection 10, in which he will continue to identify the appropriate Language. After this step, the translator will proceed to the step of Language Translation 14, after which the process ends.

A Translator would download the software to a smart phone device to implement this method invention. Such a smart Phone may include an information output device (such as a monitor or display), an information input device (such as a keyboard, touchpad, or microphone), and the mechanical means to translate Language according to a translatees preference.

The available choices for Language Translation could be presented to a translatee via the information output device. The translatee could then express a preference regarding his Language Selection via the information input device. Based on this information, the Language Translation Software could then Translate Desired Languages on the translatees input.

The Language Translation could then be served to the translatee via audio output, visual output or tactile output. The method could be used by any translator that needed Language Translation.

In a different field of technology, the field of learning a new Language, a Language Learning system may implement a variation of the method by presenting the available Language choices to the Student, receiving preference information, and then teaching a specific Language to the Student based on this information.

Language Translation, Learning a new Language, Communication with any person in the World, potential for inter-species communication.

### One Embodiment May Include

The Process of Language Translation and repetition would enable both the Translator and the Translatee to benefit from direct Language Translation as a means of communication whereas without, communication would be extremely difficult.

### Synopsis

This invention eliminates language barriers. Downloadable software to a smart phone, allows full translation from spoken language to another spoken language, allowing people who speak different languages to communicate with each other in their native language. By using the latest in Automatic Speech Recognition (ASR), Language translation and Text to Speech (TTS) it allows users to speak in their native language and the software does the translation.

1. A method substantially as described herein.
